(19) United States
(12) Patent Application Publication
(10) Pub. No.: US 2017/0245225 A1
(43) Pub. Date: Aug. 24, 2017

(54) POWER CONTROL MODE FOR D2D SYNCHRONIZATION SIGNALS

(71) Applicant: FUJITSU LIMITED, Kawasaki-shi (JP)

(72) Inventor: Chenxi ZHU, Fairfax, VA (US)

(73) Assignee: FUJITSU LIMITED, Kawasaki-shi (JP)

(21) Appl. No.: 15/588,624

(22) Filed: May 6, 2017

Related U.S. Application Data
(63) Continuation of application No. PCT/US2015/028936, filed on May 1, 2015.
(60) Provisional application No. 62/076,403, filed on Nov. 6, 2014.

(51) Int. Cl. H04W 52/38; H04W 56/00

(52) U.S. Cl. CPC H04W 52/383; H04W 56/0025; H04W 92/18

(57) ABSTRACT

A method of power control for synchronization signals includes, at a wireless device, receiving a signal from an access point that is determinative of a power control mode of the wireless device for transmission of D2D synchronization signals. The method also includes transmitting, by the wireless device, D2D synchronization signals according to the power control mode. The power control mode may include a controlled power mode or a maximal power mode.

### CROSS-REFERENCE TO RELATED APPLICATIONS

This patent application is a continuation of international patent application no. PCT/US2015/028936, filed May 1, 2015, which claims the benefit of U.S. provisional patent application no. 62/076,403, filed Nov. 6, 2014. The foregoing applications are incorporated herein by reference.

### FIELD

The embodiments discussed herein are related to a power control mode for D2D synchronization signals.

### BACKGROUND

The proliferation of smartphones, tablets, laptop computers, and other electronic devices (referred to generally as “wireless devices”) that use wireless communication networks has created an increased demand for ubiquitous and continuous wireless voice and data access. Device-to-device (D2D) communication may help satisfy this demand. For example, D2D communication may be performed between wireless devices and may allow the wireless devices to communicate information with each other. This D2D communication may allow for reuse of wireless communication resources, which may help satisfy the demand for wireless voice and data access.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method power control for synchronization signals includes, at a wireless device, receiving a signal from an access point that is determinative of a power control mode of the wireless device for transmission of D2D synchronization signals. The method also includes transmitting, by the wireless device, D2D synchronization signals according to the power control mode. The power control mode may include a controlled power mode or a maximal power mode.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram of an example wireless communication network;

FIG. 2 is a diagram of an example wireless device that may be implemented in the network of FIG. 1;

FIG. 3A is a graphical representation of PAPR calculated as a function of NIDi;

FIG. 3B is a graphical representation of the calculated PAPR of FIG. 3A arranged in ascending order of calculated PAPR;

FIG. 4 illustrates a flowchart of an example method of Long Term Evolution-Advanced (LTE-A) D2D secondary synchronization sequence design;

FIG. 5A illustrates a flowchart of an example method of transmission power control of D2D synchronization signals;

FIG. 5B illustrates a flowchart of another example method of transmission power control of D2D synchronization signals; and

FIG. 6 illustrates a flowchart of an example method of resource configuration and wireless device behavior, all arranged in accordance with at least one embodiment described herein.

### DESCRIPTION OF EMBODIMENTS

Specifications of the Long Term Evolution (LTE) system an LTE-Advanced (LTE-A) system are under investigation in the 3^{rd} Generation Partnership Project (3GPP). Each specification is often referred to as a release (rel.). Rel. 12 of the 3GPP LTE-A specification describes D2D communication. D2D communication allows direct data transmission between two or more mobile terminals described herein as user equipment (UE). The D2D communication may overlay regular cellular communications.

Using D2D communication may increase network capacity. For example, D2D communication may allow spatial reuse gain, as permitting spatial multiplexing may allow higher spectrum usage. Employing D2D communication may also allow link gain, as the throughput may be increased as a direct link may have better channel quality compared to cellular channels. Using D2D communication may further allow hop gain, as resource usage may be reduced when data is transmitted once over the direct link compared to twice over cellular links, i.e., through uplink (UL) and downlink (DL) cellular communication. Employing D2D communication may also optimize device user equipment (DUE) communication latency. For example, D2D communication may avoid relaying data through an eNodeB (eNB) and/or a core network, thus optimizing the eNB load.

In some instances, D2D communication may extend cell coverage through D2D relay. Furthermore, D2D communication may be used with or without network coverage or with partial network coverage.

D2D communications such as scheduling assignment (SA) and data may be transmitted with controlled power or maximal power. As described in more detail below, a problem may arise if D2D synchronization sequence (D2DSS) and physical D2D synchronization channel (PD2DSCH) are transmitted with controlled power when D2D communications are transmitted with maximal power. For example, the D2DSS and PD2DSCH transmissions transmitted with controlled power may have less transmission power and less transmission range than D2D communications transmitted with maximal power. As such, some receiving wireless devices may not obtain synchronization from D2DSS/PD2DSCH and may therefore be unable to decode D2D communications properly, even if the D2D communications are received with sufficient power to be decoded.

Accordingly, some embodiments described herein may receive, at a wireless device, a signal from an access point that is determinative of a power control mode of the wireless device for transmission of D2D synchronization signals, such as D2DSS and/or PD2DSCH. The signal received from the access point may include a downlink control information (DCI), subframe 5 (DCI5), a radio resource control (RRC) signal, or a signal effective to configure (alpha, P0) parameters of the wireless device. The wireless device may then transmit D2D synchronization signals according to the power control mode, where the power control mode includes a controlled power mode or a maximal power mode. In some embodiments, the power control mode for transmission of the D2D synchronization signals may match a power control mode for transmission of D2D communications.

Embodiments of the present invention will be explained with reference to the accompanying drawings.

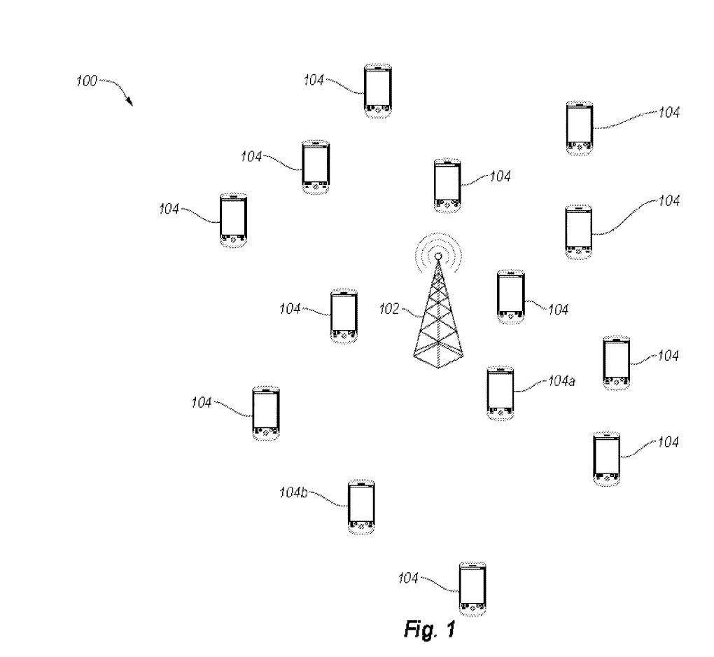

FIG. 1 is a diagram of an example wireless communication network 100 (hereafter “network 100”), arranged in accordance with at least one embodiment described herein. The network 100 may be configured to provide wireless communication services to one or more wireless devices 104 (hereafter “wireless device 104” or “wireless devices 104”) via one or more access points, such as an access point 102. The wireless communication services may be voice services, data services, messaging services, and/or any suitable combination thereof. The network 100 may include a Frequency Division Multiple Access (FDMA) network, an Orthogonal FDMA (OFDMA) network, a Code Division Multiple Access (CDMA) network, a Time Division Multiple Access (TDMA) network, and/or any other suitable wireless communication network. In some embodiments, the network 100 may be configured as a third generation (3G) wireless communication network and/or a fourth generation (4G) wireless communication network. In these or other embodiments, the network 100 may be configured as an LTE or LTE-A wireless communication network. In the network 100 of FIG. 1, the wireless devices 104 may include DUEs which may discover other nearby wireless devices 104, described herein as “D2D discovery.” The wireless devices 104 may use such information for UE-location-based services and/or for direct, D2D communication.

D2D transmission may occur between one wireless device 104 and one other wireless device 104 within transmission range, described herein as a “unicast.” Alternately or additionally, D2D transmission may occur between one wireless device 104 and a subset of all the other wireless devices 104 within transmission range, described herein as a “group cast.” Alternately or additionally, D2D transmission may occur between one wireless device 104 and all other wireless devices 104 within transmission range, described herein as a “broadcast.”

The D2D discovery and the D2D communication may take place between wireless devices 104 in the network 100 with full network coverage, partial network coverage or no network coverage. With full or partial network coverage, D2D discovery and D2D communication may take place with centralized coordination, e.g., coordination by the access point 102. There are a number of potential applications for D2D communication. For example, D2D communication may be employed in public safety situations such as emergency response scenarios. In such scenarios, D2D communication may be used for short-range discovery & communications between first responders (or more particularly, wireless devices 104 of the first responders), particularly where the first responders are a short distance away from one another. In some instances D2D communications may allow the wireless devices 104 to be used in a manner similar to walkie-talkies and/or may allow the first responders to make group calls.

Furthermore, D2D communication may be used for social purposes, such as allowing people to discover, share files and/or communicate with people of interest in the vicinity using their wireless devices 104.

Furthermore, D2D communication may be used for commercial purposes, such as proximity-based advertisement.

Furthermore, D2D communication may be used for transportation purposes, such as car-to-car and/or car-to-curb communications.

Furthermore, D2D communication may be used for machine-to-machine (M2M) purposes, such as in a smart home, e.g., for peer-to-peer communication between smart home appliances. D2D communication may also be used to directly support M2M groups.

There is special interest in D2D communication from the public safety community, as represented by the U.S. Department of Commerce (USDOC). Besides typical usage, the public safety applications may also require D2D broadcast and D2D group cast. A D2D broadcast may target all the wireless devices 104 within the transmission range of a transmitting (TX) wireless device 104. A D2D group cast may target all the wireless devices 104 that are part of a communication group within the transmission range of the TX wireless device 104.

With continued reference to FIG. 1, the access point 102 may be any suitable wireless communication network communication point and may include, by way of example, a base station, an evolved node B (eNB) base station, a remote radio head (RRH), or any other suitable communication point. The wireless devices 104 may include any devices that may use the network 100 for obtaining wireless communication services and may include, by way of example, a DUE, an M2M device, a cellular phone, a smartphone, a personal data assistant (PDA), a laptop computer, a personal computer, and a tablet computer, or any other similar device.

The wireless devices 104 may be configured to perform D2D communication. In some embodiments, the wireless devices 104 may be configured to perform D2D communication both with assistance from the access point 102 and without assistance from the access point 102. Performing D2D communication with assistance from the access point 102 may be described herein as “in-network” D2D communication. Performing D2D communication without assistance from the access point 102 may be described herein as “out-of-network” D2D communication. In some embodiments, in-network D2D communication may be performed while the wireless devices 104 are connected to the access point 102 and out-of-network D2D communication may be performed while the wireless devices 104 are not connected to the access point 102. For example, the wireless devices 104 may perform out-of-network D2D communication while the wireless devices 104 are outside of a communication range of the access point 102.

To perform in-network or out-of-network D2D communication, individual wireless devices 104 may discover other wireless devices 104 with which the wireless devices 104 may wirelessly communicate. For example, a first wireless device 104a may discover a second wireless device 104b. Wireless devices may discover each other using D2D discovery messages.

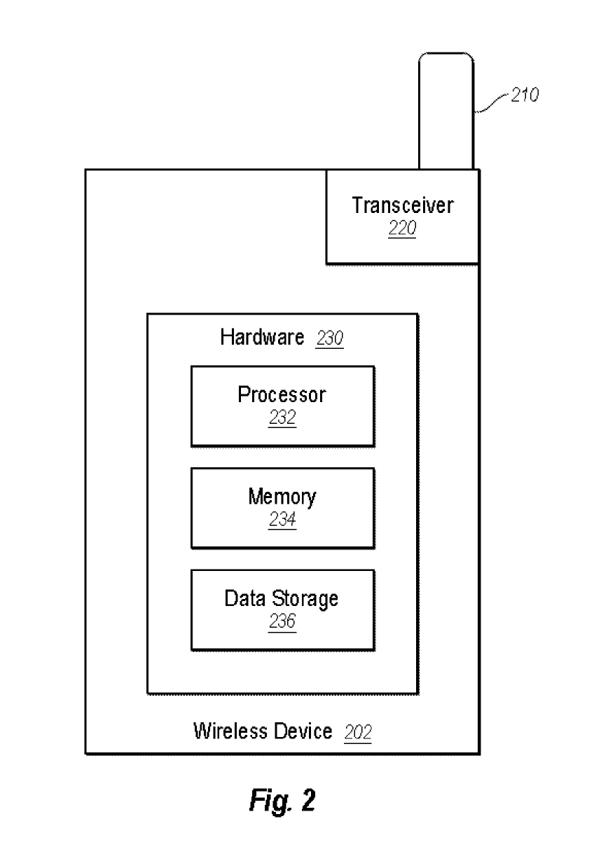

FIG. 2 is a diagram of an example wireless device 202 that may be implemented in the network 100 of FIG. 1, arranged in accordance with at least one embodiment described herein. The wireless device 202 may generally correspond to the wireless devices 104 of FIG. 1. The wireless device 202 may include an antenna 210, a transceiver 220, and hardware 230. The hardware 230 may include an application-specific integrated circuit (ASIC), a Field-Programmable Gate Array (FPGA), or any other digital or analog circuitry configured to perform operations, such as the operations described as performed by the wireless devices 104 of FIG. 1. As illustrated in FIG. 2, the hardware 230 may include a processor 232, a memory 234, and data storage 236. In these and other embodiments, the processor 232, the memory 234, and the data storage 236 may be configured to perform some or all of the operations performed by the hardware 230. In other embodiments, the hardware 230 may not include one or more of the processor 232, the memory 234, and the data storage 236.

Generally, the processor 232 may include any suitable special-purpose or general-purpose computer, computing entity, or processing device including various computer hardware or software modules and may be configured to execute instructions stored on any applicable computer-readable storage media. For example, the processor 232 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 2, the processor 232 may include any number of processors configured to perform individually or collectively any number of operations described herein. Additionally, one or more of the processors may be present on one or more different electronic devices. In some embodiments, the processor 232 may interpret and/or execute program instructions and/or process data stored in the memory 234, the data storage 236, or the memory 234 and the data storage 236. In some embodiments, the processor 232 may fetch program instructions from the data storage 236 and load the program instructions in the memory 234. After the program instructions are loaded into the memory 234, the processor 232 may execute the program instructions.

The memory 234 and data storage 236 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 232. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 232 to perform a certain operation or group of operations.

Although not illustrated, an access point, such as the access point 102 of FIG. 1, may include at least some elements that are similar or analogous to the elements of the wireless device 202 of FIG. 2. For example, an access point according to at least one embodiment described herein may include hardware, a transceiver, and an antenna, analogous to the hardware 230, the transceiver 220, and the antenna 210 of the wireless device 202 of FIG. 2. Additionally, the hardware of the access point may include one or more of a processor, a memory, and data storage, analogous to the processor 232, the memory 234, and the data storage 236 of the wireless device 202 of FIG. 2.

1. LTE-A D2D Secondary Synchronization Sequence Design

With combined reference to FIGS. 1 and 2, D2D discovery messages that may be transmitted by the wireless devices 104, 202 may include D2D synchronization signals (D2DSS or D2DSS transmissions) and physical D2D synchronization channel (PD2DSCH or PD2DSCH transmissions). D2DSS transmissions and PD2DSCH transmissions include transmissions by a corresponding one of the wireless devices 104, 202 to provide synchronization to others of the wireless devices 104, 202 within its transmission range. Each D2DSS and/or PD2DSCH transmission may serve as time and/or frequency synchronization for reception by others of the wireless devices 104, 202 from the corresponding one of the wireless devices 104, 202. D2DSS transmissions can be transmitted by in-network, partial-network, or out-of-network coverage wireless devices 104, 202.

D2DSS transmissions include primary D2D synchronization sequence transmissions (PD2DSS or PD2DSS transmissions) and secondary D2D synchronization sequence transmissions (SD2DSS or SD2DSS transmissions). Each PD2DSS transmission may be used by a corresponding receiving (RX) wireless device 104, 202 for initial time and frequency estimation. Each SD2DSS transmission may be used by the corresponding RX wireless device 104, 202 for fine time and frequency estimation.

Although the current 3GPP LTE/LTE-A specification (Rel.8-11) does not support D2D, the current 3GPP LTE/LTE-A specification (Rel.8-11) defines non-D2D primary synchronization sequence transmissions (PSS transmissions or PSS) and non-D2D secondary synchronization sequence transmissions (SSS transmissions or SSS) that are respectively analogous to PD2DSS transmissions and SD2DSS transmissions. The current 3GPP LTE/LTE-A specification (Rel.8-11) is incorporated herein by reference.

A meeting agreement referred to as the RAN1#78 meeting agreement defines aspects of PD2DSS and SD2DSS. Documents associated with the RAN1#78 meeting are available at http://www.3gpp.org/ftp/Meetings_3 GPP SYNC/RAN1/Inbox/Chairman_notes/(accessed on Nov. 3, 2014) and are incorporated herein by reference. The RAN1#78 meeting agreement specifies various aspects of PD2DSS transmissions. For example, a PD2DSS sequence may include new root indices; detailed root indices are a topic for further study (FFS). Additionally, a waveform of the PD2DSS may include single-carrier frequency division multiplexing (SC-FDM) without discrete Fourier transform (DFT)-precoding. Further, a number of symbols in a subframe of the PD2DSS may include two symbols.

The Ran1#78 meeting agreement also specifies various aspects of SD2DSS transmissions. For example, a sequence of an SD2DSS transmission may include any of the same sequences as for Rel-8 SSS. Additionally, a waveform of each SD2DSS transmission may include SC-FDM without DFT-precoding and with reduced power compared to PD2DSS transmissions. A topic FFS of the Ran1#78 meeting includes how to specify reduced power mechanism for SD2DSS transmissions. Further, a number of symbols in a subframe of each SD2DSS transmission may include two. Some embodiments described herein relate to the sequences of SD2DSS transmissions.

The PSS and SSS transmissions will be described in more detail before explaining example embodiments relating to SD2DSS transmissions. A cell search is a process by which a receiver acquires time and frequency synchronization with a cell and detects a physical layer Cell identifier (ID) of that cell. In LTE systems, this process may be facilitated by the use of the PSS and the SSS. Synchronization signals (e.g., PSS and SSS) are specific sequences inserted into the last two orthogonal frequency division multiplexing (OFDM) symbols in the first slot of subframes zero and five. The PSS is carried on a PSS channel (PSSC) and the SSS is carried on a SSS channel (SSSC). The PSS is typically used for timing and frequency acquisition whereas the SSS is typically used to acquire the Cell ID and other cell-specific information. Both the PSSC and the SSSC may be located in a 960 kilohertz (kHz) band at the center of the signal and may arrive in a symbol every 5 milliseconds (ms). There are 3 possibilities of PSS and 168 possibilities of SSS. Thus, there are 3*168=504 possible combinations of PSS and SSS, each combination of which is referred to as a Cell ID. The three possibilities of PSS may be referred to as NID₂, NID₂ (0˜2), or indices NID₂ and the 168 possibilities of SSS may be referred to as NID₁, NID₁ (0˜167), or indices NID₁.

For Rel-8 SSS, the SSS sequence may be a function of NID₁ (0˜167) and NID₂ (0˜2), and a subframe number (SFN=0 or 5). The SSS sequence may be represented as SSS(NID₁, NID₂, SFN). A downlink (DL) SSS may be modulated as an OFDM symbol. SD2DSS may be transmitted as SC-FDM without DFT. Due to the RAN1#78 meeting agreement that SD2DSS use the same sequence as SSS, the design of SD2DSS may be limited to choosing the SD2DSS sequence from the set of SSS sequences.

SD2DSS may occupy two symbols. Up to two sequences may be needed for SD2DSS. If all SSS sequences are used as-is for SD2DSS sequences, it may lead to large peak-to-average-power ratio (PAPR) and cubic metric (CM), potentially degrading signal quality. This may require the SD2DSS to be transmitted with lower power than PD2DSS. Lower transmission power of SD2DSS may degrade SD2DSS receiving performance.

When a D2DSS (e.g., PD2DSS/SD2DSS) transmission is transmitted with PD2DSCH, the D2DSS may carry a subframe number (SFN) (e.g., when in network coverage) or a D2D frame number (DFN) (e.g., when out of network coverage). Both SFNs and DFNs may be generically referred to herein as subframe numbers. In these and other embodiments, it may be unnecessary to transmit different SD2DSS waveforms in two symbols. For the example of inter-cell discovery only, D2DSS may be transmitted alone (e.g., without PD2DSS). Alternatively or additionally, the resources and related subframe number may be signaled by the access point 102 through a system information block (SIB). Accordingly, it may be unnecessary to indicate the subframe number with SD2DSS in this example. In these and other examples, embodiments described herein may transmit the two SD2DSS symbols (1 and 2) using the same sequence and waveform. As such, the corresponding RX wireless device 104, 202 may combine the two SD2DSS symbols for a better detection result. The sequence of SSS in subframe 0 may be used to transmit the two SD2DSS symbols (1 and 2). Alternately or additionally, the SD2DSS sequence may be represented in this or other examples according to equation 1:

SD2DSS(NID₁, NID₂)=SSS(NID₁, mod(NID₂,3), 0), eq. 1

In equation 1, mod( ) is a modulo function. For a given combination of NID₁ and NID₂, equation 1 outputs the SSS sequence in subframe 0 for that NID₁ and (NID₂ modulo 3). An SSS sequence may be generated using NID₁(0˜167) and NID₂(0˜2). For D2DSS, PD2DSS may carry NID₂. The SD2DSS sequence generated as SD2DSS(NID₁, NID₂) (or as SSS(NID₁, mod(NID₂,3), 0)) may have a wide range of PAPR and CM. Now suppose SD2DSS PAPR (which may be equivalent to SSS PAPR) is defined as a function of NID₁ according to equation 2:

PAPR(NID₁)=max_{NID2}PAPR(SD2DSS(NID₁, mod(NID₂,3))), eq. 2

In equation 2, max is a maximization function. For a given NID₁, equation 2 outputs a highest SD2DSS PAPR from among three different SD2DSS PAPRs corresponding to the three possibilities of PSS (e.g., NID₂ (0˜2)) for the given NID₁.

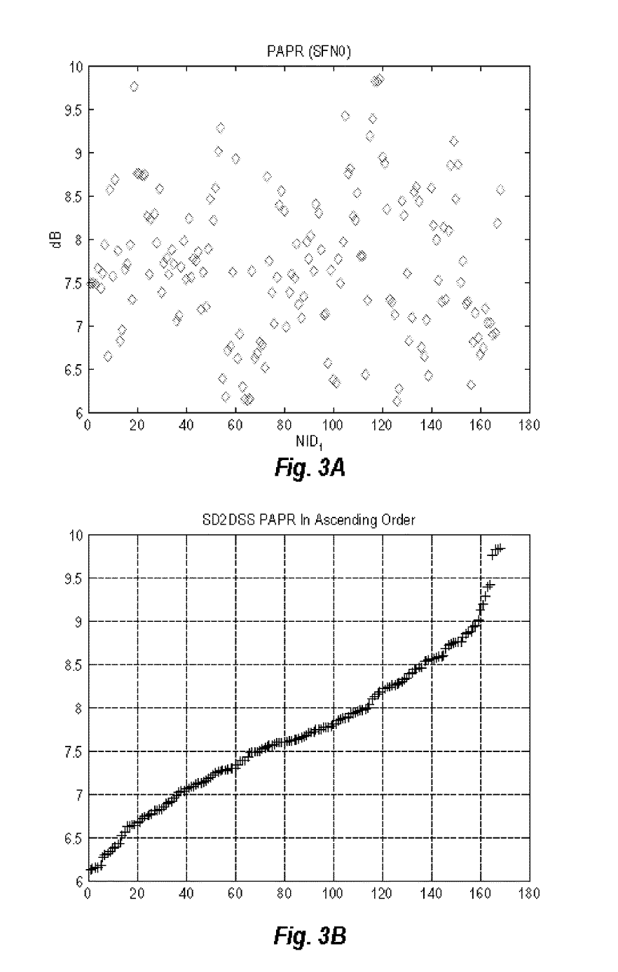

FIG. 3A is a graphical representation of PAPR calculated as a function of NID₁ according to equation 2, arranged in accordance with at least one embodiment described herein. FIG. 3B is a graphical representation of the calculated PAPR of FIG. 3A arranged in ascending order of calculated PAPR, arranged in accordance with at least one embodiment described herein.

As illustrated in FIGS. 3A and 3B, if every SSS sequence is used, maximal PAPR is fairly large, e.g., about 9.84 decibels (dB). Such a large maximal PAPR may require a relatively large power backoff with respect to PD2DSS and may reduce performance (detection probability and channel estimation) of SD2DSS. According to embodiments described herein, however, a subset of N SSS sequences with relatively low PAPR and/or relatively low CM may be selected as available for use as SD2DSS sequences. The selection of the subset of N SSS sequences reduces the effective range of NID₁, but may allow higher transmission power of SD2DSS. As an example, when the N=100 sequences of FIGS. 3A and 3B with the lowest PAPRs are selected such that the 168−N (or 68 for N=100) remaining sequences with the higher PAPRs are excluded from use as SD2DSS sequences, the maximal PAPR is only about 7.8 dB, as opposed to about 9.84 dB. Accordingly, a wireless device may transmit SD2DSS with 2 dB higher power when N=100 before the worst case scenario (e.g., PAPR=7.8 dB) for N=100 approximately reaches the maximal PAPR (e.g., 9.84 dB) when the entire set of 168 possible sequences is considered. In these and other embodiments, indices NID₁ of the selected subset of N SSSS may not be contiguous, whereas indices NID₁ ({0, . . . , N−1}) of the set of N SD2DSSs may be contiguous. Accordingly, a mapping between the indices NID₁ of the selected subset of N SSSS and the indices NID₁ of the set of N SD2DSSs may be defined. The mapping may be defined in the standard specification or in one or more proprietary mappings.

In these and other embodiments, the SD2DSS may be transmitted with a fixed power backoff with respect to the PD2DSS. The fixed power backoff may be calculated by comparing the maximal PAPRs of PD2DSS and SD2DSS sequences, referred to herein as maximal PAPR(PD2DSS) and maximal PAPR(SD2DSS). For example, if maximal PAPR(SD2DSS)−maximal PAPR(PD2DSS)=x dB, all SD2DSS transmissions may be transmitted with x dB power backoff with respect to PD2DSS, or x dB less power than PD2DSS. In this and other embodiments, the maximal PAPR(SD2DSS) may be determined as the maximum PAPR of the N sequences of FIGS. 3A and 3B with the N lowest PAPRs, and the PAPR of the PD2DSS.

Alternatively, the SD2DSS power backoff may be set individually by comparing the PAPR of the SD2DSS sequence and the PD2DSS sequence. For example, for a given SD2DSS and PD2DSS pair, if PAPR(SD2DSS)−PAPR(PD2DSS)=x dB, SD2DSS may be transmitted with x dB power backoff with respect to PD2DSS, or x dB less power than PD2DS S.

In some embodiments, the set of N SD2DSS sequences (which is the same as the subset of N SSS sequences) may be further divided into two or more subsets based on the corresponding PAPR and/or CM. Each subset may contain SD2DSSs with PAPR and/or CM that are within a particular range of PAPR and/or CM. The subsets may have non-overlapping ranges of PAPR and/or CM. The configuration of SD2DSS into different subsets may be done in SIB or radio resource control (RRC) or pre-configuration.

The subset of SD2DSS with the relatively larger PAPR and/or CM may be used by wireless devices 104, 202 within network coverage subject to power control (with respect to the access point 102). The access point 102 may configure SD2DSS for an RRC_CONNECTED wireless device 104, 202 through RRC configuration.

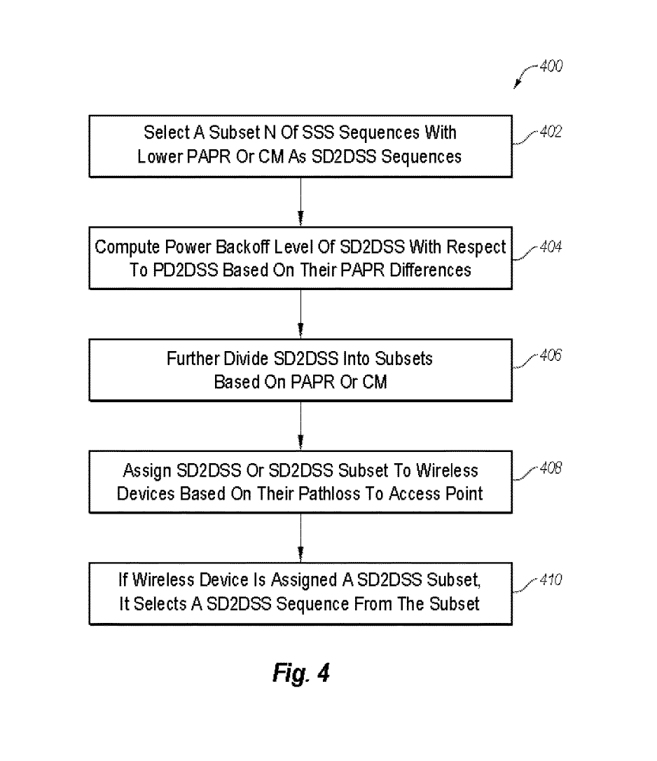

Out of network wireless devices 104, 202 may be configured to select SD2DSS from one or more of the subsets of SD2DSS. Pre-configuration or RRC signaling may be used to determine which SD2DSS is to be used by such out of network wireless devices 104, 202. FIG. 4 illustrates a flowchart of an example method 400 of LTE-A D2D secondary synchronization sequence design, arranged in accordance with at least one embodiment described herein. The method of FIG. 4 may be implemented, in whole or in part, by the access point 102 or wireless devices 104, 202 of FIG. 1 or 2, an eNB, a UE, or other LTE-A network element, computing device, or communication device.

The method 400 of FIG. 4 may include selecting 402 a subset N of SSS sequences with lower PAPR and/or CM as a set of SD2DSS sequences. Alternatively or additionally, prior to selecting the subset N of SSS sequences with lower PAPR and/or CM as a set of SD2DSS sequences, the method 400 may include calculating PAPR for each of the SSS sequences according to equation 2 above. Selecting the subset N of SSS sequences may include selecting N SSS sequences with the N lowest PAPRs. Alternatively or additionally, and because the indices NID₁ of selected N SD2DSS sequences may not be contiguous, the method 400 may further include defining a mapping between the selected subset N of NID₁ ({0, . . . , N−1}) and NID₁.

The method 400 may also include computing 404 a power backoff level of SD2DSS with regard to PD2DSS based on their PAPR differences. Examples of computing a power backoff level are described above.

The method 400 may also include dividing 406 the set of SD2DSS sequences into subsets based on PAPR and/or CM. Each subset may contain SD2DSS with PAPRs and/or CMs that are within a particular range of PAPR and/or CM. The subsets of SD2DSS sequences may have non-overlapping ranges of PAPR and/or CM. The configuration of SD2DSS into different subsets may be done in SIB or radio resource control (RRC) or pre-configuration. The method 400 may also include assigning 408 one or more particular SD2DSS or subsets of SD2DSS to wireless devices (e.g., wireless devices 104, 202 of FIGS. 1 and 2) based on the pathloss of the wireless devices to the access point or eNB (e.g., the access point 102 of FIG. 1).

The method 400 may also include, for each wireless device assigned to an SD2DSS subset, selecting an SD2DSS sequence from the subset.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed implementations.

Embodiments described herein may include one or more non-transitory computer-readable media having computer instructions stored thereon that are executable by a processor device to perform or control performance of one or more of the operations of FIG. 4. For example, the memory 234 and/or the data storage 236 of the wireless device 202 of FIG. 2 may have computer instructions stored thereon that are executable by the processor 232 of FIG. 2 to perform or control performance of one or more of the operations of FIG. 4. Alternatively or additionally, a non-transitory computer-readable medium (such as a memory or a data storage) of the access point 102 of FIG. 1 may have computer instructions stored thereon that are executable by a processor of the access point 102 to perform or control performance of one or more of the operations of FIG. 4.

2. Power Control Mode For LTE-A D2D Synchronization Signals

Referring again to FIGS. 1 and 2, D2DSS and PD2DSCH include transmissions by the wireless devices 104, 202 to provide synchronization to other wireless devices 104, 202 within transmission range. The D2DSS and/or PD2DSCH transmission may serve as time and/or frequency synchronization for reception by the other wireless devices 104, 202 from the corresponding one of the wireless devices 104, 202. D2DSS can be transmitted by in-network, partial-network, or out-of-network coverage wireless devices 104, 202. D2DSS may include PD2DSS and SD2DSS.

D2DSS and PD2DSCH may be subject to open loop power control with respect to pathloss to the access point 102. A dedicated set of power control parameters (alpha, P0) may be used in the open loop power control. Due to different PAPRs, SD2DSS and PD2DSCH may be transmitted with reduced power levels (with possibly different power back off values) with respect to PD2DSS.

D2D communications may include scheduling assignment (SA) and data, sometimes represented as (SA, data). D2D communication (SA, data) may be subject to power control with its own parameters. Transmission with maximal power may also be supported. In an access point 102 instruction to the wireless device 104, 202, which instruction may be included in downlink control information (DCI), subframe 5 (DCI5), a single bit may be used to instruct the wireless device 104, 202 regarding which of multiple power control modes (e.g., maximal power mode or controlled power mode) is used. A bit used in DCI5 to instruct the wireless device 104, 202 regarding which power control mode to use may be referred to as a transmission power control bit. SA and data may switch between the two power control levels or modes responsive to instructions from the access point 102, which instructions may be indicated by the transmission power control bit.

A problem may arise if D2DSS and PD2DSCH are limited to transmission in controlled power mode in which the D2DSS and PD2DSCH synchronization signals may be transmitted by the wireless device 104, 202 with less than full power. For example, when SA and data are transmitted with maximal power (e.g., full power), if D2DSS and PD2DSCH (hereinafter “D2DSS/PD2DSCH”) are transmitted with controlled power, they may have less transmission power and less transmission range than SA and data. As such, some RX wireless devices 104, 202 may not obtain synchronization from D2DSS/PD2DSCH (e.g., they may be out of range of lower-power D2DSS/PD2DSCH) and may therefore be unable to decode SA and data properly due to lack of synchronization, even if SA and data are received with sufficient power to be decoded.

In some embodiments described herein, however, D2DSS/PD2DSCH may be transmitted with maximal power (e.g., full power) to match the transmission power of the SA and data when SA and data are also being transmitted with maximal power. Transmission of D2DSS/PD2DSCH with maximal power may be accomplished according to one or more of the following schemes.

Under a first scheme, when the wireless device 104, 202 receives DCI5 from the access point 102 to use maximal transmission power for SA and data, the wireless device 104, 202 automatically transmits D2DSS/PD2DSCH with maximal power. When transmission of SA and data switches back to transmission with controlled power level, the D2DSS and/or the PD2DSCH is also transmitted with controlled power level. Accordingly, under the first scheme, the transmission power control bit in DCI5 may, in addition to determining transmission power for SA and DATA, also determine transmission power for D2DSS and PD2DSCH.

Under a second scheme, before the access point 102 sends DCI5 to the wireless device 104, 202 to switch to maximal transmission power for SA and data, it configures the wireless device 104, 202 (e.g., through RRC) to transmit with maximal power level. Configuring the wireless device 104, 202 may be done with a dedicated bit in the RRC signal. The dedicated bit in the RRC signal may instruct the wireless device 104, 202 which power control mode (e.g., maximal power or controlled power) to use for D2DSS and PD2DSCH. For example, the dedicated bit may be set, or may have a first value (e.g., 1), to indicate one of the two power control modes and may not be set, or may have a second value (e.g., 0), to indicate the other of the two power control modes. Alternately or additionally, the access point 102 may configure the wireless device 104, 202 with (alpha, P0) parameters corresponding to the appropriate power control mode to allow maximal power transmission or controlled power transmission of D2DSS and PD2DSCH, as determined by the access point 102.

Under both the first and the second schemes, the wireless device 104, 202 may transmit in a corresponding one of the two power control modes as constrained and signaled by the access point 102. For example, under the first scheme, the wireless device 104, 202 may transmit D2DSS/PD2DSCH with maximal power responsive to receiving DCI5 from the access point 102 instructing transmission of SA and data with maximal transmission power or may transmit D2DSS/PD2DSCH with controlled power responsive to receiving DCI5 from the access point 102 instructing transmission of SA and data with controlled power. As another example, under the second scheme, the wireless device 104, 202 may transmit D2DSS/PD2DSCH with maximal power responsive to receiving an RRC signal from the access point 102 that sets the wireless device 104, 202 to maximal power or configures (alpha, P0) parameters for maximal power, or may transmit D2DSS/PD2DSCH with controlled power responsive to receiving an RRC signal from the access point 102 that sets the wireless device 104, 202 to controlled power or configures (alpha, P0) parameters for controlled power.

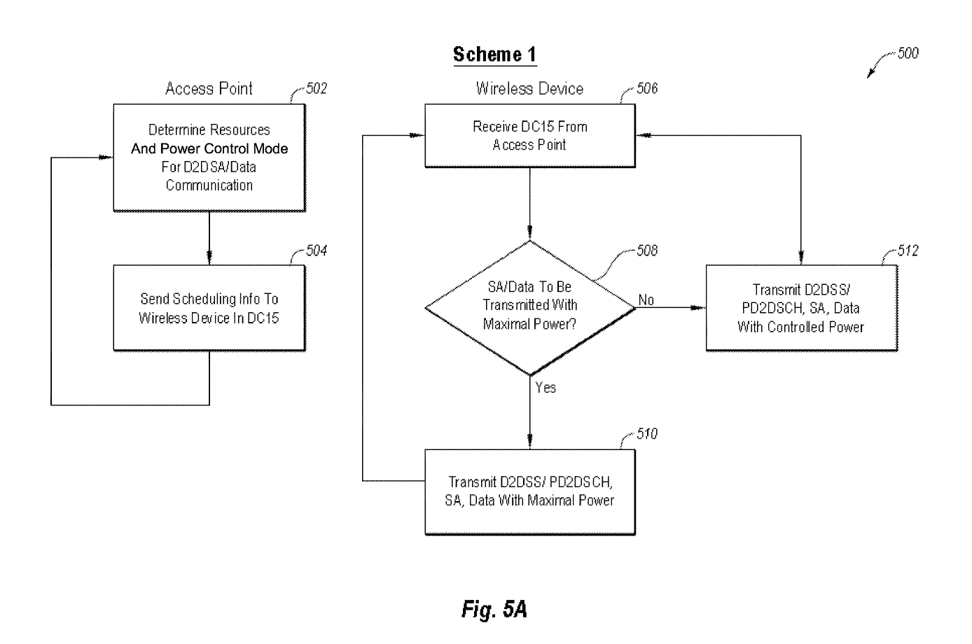

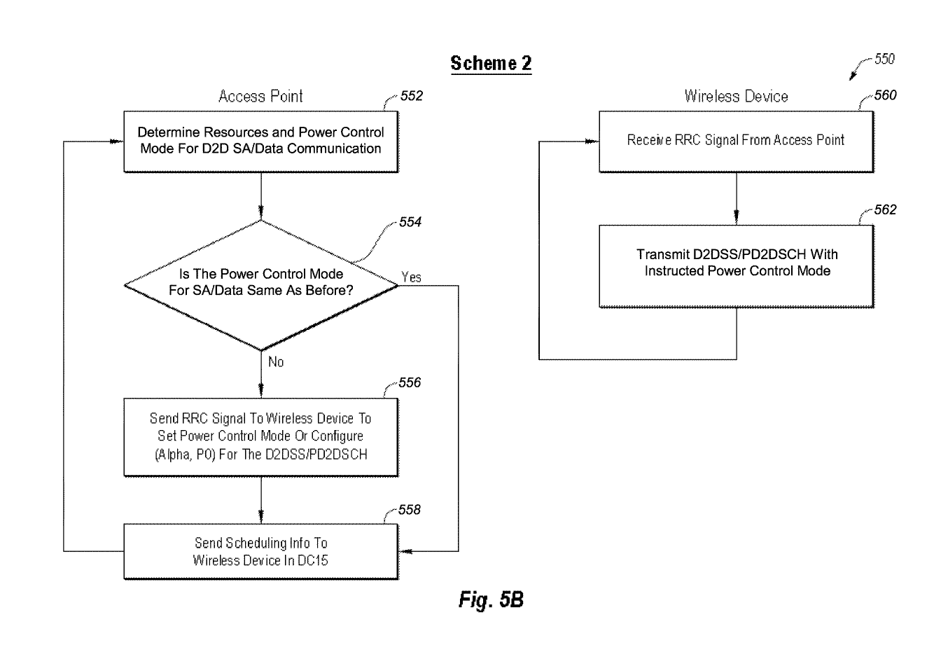

FIG. 5A illustrates a flowchart of an example method 500 of transmission power control of D2D synchronization signals, arranged in accordance with at least one embodiment described herein. The method 500 of FIG. 5A may correspond to the first scheme described above, and is labeled in FIG. 5A as “Scheme 1.” The method 500 of FIG. 5A may be implemented, in whole or in part, by the access point 102 or wireless devices 104, 202 of FIG. 1 or 2, an eNB, a UE, or other LTE-A network element, computing device, or communication device. For example, in FIG. 5A, the labels “Access Point” and “Wireless Device” are above various blocks that represent operations that may be performed by, respectively, the access point 102 and the wireless device 104, 202 of FIG. 1 or 2.

The method 500 of FIG. 5A may include the access point 102 determining 502 resources and a power control mode for D2D SA and data communication. The power control mode may include maximal power (or maximal power mode) or controlled power (or controlled power mode). The method 500 may also include the access point 102 sending scheduling information to the wireless device 104, 202 in DCI5. The scheduling information may include the transmission power control bit that may indicate the determined power control mode for D2D SA and data communication. The transmission power control bit being set, or having a first value (e.g., 1), may indicate the maximal power mode, whereas the transmission power control bit not being set, or having a second value (e.g., 0), may indicate the controlled power mode, or vice versa.

The method 500 may also include the wireless device 104, 202 receiving 506 DCI5, including the transmission power control bit, from the access point 102. The method 500 may also include the wireless device 104, 202 determining 508, based on the DCI5, whether SA and data are to be transmitted with maximal power. For example, if the transmission power control bit in DCI5 is set, the wireless device 104, 202 may determine 508 that the SA and data are to be transmitted with maximal power. Or, if the transmission power control bit in DCI5 is not set, the wireless device 104, 202 may determine 508 that the SA and data are not to be transmitted with maximal power and instead are to be transmitted with controlled power.

In response to determining that SA and data are to be transmitted with maximal power (“Yes” at block 508), the method 500 may also include the wireless device 104, 202 transmitting D2DSS, PD2DSCH, SA, and data with maximal power, after which the method 500 may loop (e.g., return to one or more of blocks 502 and 506). In response to determining that SA and data are not to be transmitted with maximal power (“No” at block 508), the method 500 may also include the wireless device 104, 202 transmitting D2DSS, PD2DSCH, SA, and data with controlled power, after which the method 500 may loop (e.g., return to block 502 and 506).

Embodiments described herein may include one or more non-transitory computer-readable media having computer instructions stored thereon that are executable by a processor device to perform or control performance of one or more of the operations of FIG. 5A. For example, the memory 234 and/or the data storage 236 of the wireless device 202 of FIG. 2 may have computer instructions stored thereon that are executable by the processor 232 of FIG. 2 to perform or control performance of one or more operations of FIG. 5A, such as one or more of blocks 506, 508, 510, and/or 512. Alternatively or additionally, a non-transitory computer-readable medium (such as a memory or a data storage) of the access point 102 of FIG. 1 may have computer instructions stored thereon that are executable by a processor of the access point 102 to perform or control performance of one or more of the operations of FIG. 5A, such as one or more of blocks 502 and/or 504.

FIG. 5B illustrates a flowchart of another example method 550 of transmission power control of D2D synchronization signals, arranged in accordance with at least one embodiment described herein. The method 550 of FIG. 5B may correspond to the second scheme described above, and is labeled in FIG. 5B as “Scheme 2.” The method 550 of FIG. 5B may be implemented, in whole or in part, by the access point 102 or wireless devices 104, 202 of FIG. 1 or 2, an eNB, a UE, or other LTE-A network element, computing device, or communication device. For example, in FIG. 5B, the labels “Access Point” and “Wireless Device” are above various blocks that represent operations that may be performed by, respectively, the access point 102 and the wireless device 104, 202 of FIG. 1 or 2.

The method 550 of FIG. 5B may include the access point 102 determining 552 resources and a power control mode for D2D SA and data communication. The power control mode may include maximal power (or maximal power mode) or controlled power (or controlled power mode). The method 550 may also include the access point 102 determining 554 whether the determined power control mode for D2D SA and data communication is the same as it was prior to the determination of resources and power control mode for D2D SA and data communication.

In response to determining that the determined power control mode is the same as it was before (“Yes” at block 554), the method 550 may also include the access point 102 sending 558 scheduling information to the wireless device 104, 202 in DCI5. In response to determining that the determined power control mode is not the same as it was before (“No” at block 554), the method 550 may also include the access point 102 sending 556 an RRC signal to the wireless device 104, 202 to set the power control mode or configuring (alpha, P0) parameters of the wireless device 104, 202 for the D2DSS and PD2DSCH according to the determined power control mode. For example, the access point 102 may send 556 the RRC signal to the wireless device 104, 202 to set the power control mode or may send a signal effective to configure (alpha, P0) parameters of the wireless device 104, 202 for the D2DSS and PD2DSCH according to the determined power control mode of maximal power or controlled power. The method 550 may also include, after sending the RRC signal and/or configuring (alpha, P0) parameters of the wireless device 104, 202, the access point 102 sending 558 scheduling information to the wireless device 104, 202 in DCI5.

The method 550 may also include the wireless device 104, 202 receiving 560 the RRC signal from the access point 102 or the wireless device 104, 202 having (alpha, P0) parameters configured by the access point 102. The method 550 may also include the wireless device 104, 202 transmitting 562 D2DSS and PD2DSCH according to the instructed power control mode instructed in the RRC signal from the access point 102 or according to the power control mode instructed by configuration of (alpha, P0) parameters of the wireless device 104, 202 by the access point 102.

Embodiments described herein may include one or more non-transitory computer-readable media having computer instructions stored thereon that are executable by a processor device to perform or control performance of one or more of the operations of FIG. 5B. For example, the memory 234 and/or the data storage 236 of the wireless device 202 of FIG. 2 may have computer instructions stored thereon that are executable by the processor 232 of FIG. 2 to perform or control performance of one or more operations of FIG. 5B, such as one or more of blocks 560 and/or 562. Alternatively or additionally, a non-transitory computer-readable medium (such as a memory or a data storage) of the access point 102 of FIG. 1 may have computer instructions stored thereon that are executable by a processor of the access point 102 to perform or control performance of one or more of the operations of FIG. 5B, such as one or more of blocks 552, 554, 556, and/or 558.

3. LTE-A D2D Resource Configuration and UE Behavior

Referring again to FIGS. 1 and 2, four types of D2D resources (or resource pools) may be implemented in LTE-A networks, such as the network 100, that may, in some cases, partially or completely overlap. The four types of D2D resources may include synchronization resource (e.g. for transmission D2DSS and/or PD2DSCH), discovery, SA (sometimes referred to herein as “D2D SA”), and D2D data (sometimes referred to herein as “data”). D2D SA and data are sometimes collectively referred to as communication. From a point of view of the wireless device 104, 202, up to four discovery transmission pools, up to four mode-2 SA transmission pools, and up to four mode-2 data resource pools may be defined.

Embodiments described herein may define wireless device 104, 202 behavior with overlapping or partially overlapping D2D resources. When a D2D resource is included in multiple defined resource pools and a TX wireless device 104, 202 has more than one type of signal or message to transmit, the TX wireless device 104, 202 may decide which signal or message to transmit according to the wireless device 104, 202 behavior described herein. In these and other embodiments, the wireless device 104, 202 may behave according to a set of priority rules (discussed below) for transmitting different types of D2D signals and/or messages in overlapping resources.

In these and other embodiments, if a PD2DSCH is transmitted, it may generally or always be transmitted in the same physical resource blocks (PRBs) as D2DSS. According to the set of priority rules, a synchronization signal may have higher priority than discovery, SA, or data resources. If the synchronization signal indicates the type of D2D (discovery or communication) in the upcoming resources, and the TX wireless device 104, 202 decides which one (discovery or communication) it will transmit in the following D2D resources (before the next synchronization resource), it will transmit the synchronization signal indicating the upcoming D2D traffic type.

Between discovery and communication SA/data, the TX wireless device 104, 202 may decide which one it will transmit. No mandatory behavior may be defined in this circumstance. The wireless device 104, 202 may decide based on its high layer requirements. If the SA is not transmitted, the wireless device 104, 202 may not transmit data in the following resources that would otherwise be indicated by the SA. Between SA and data, SA may be transmitted first.

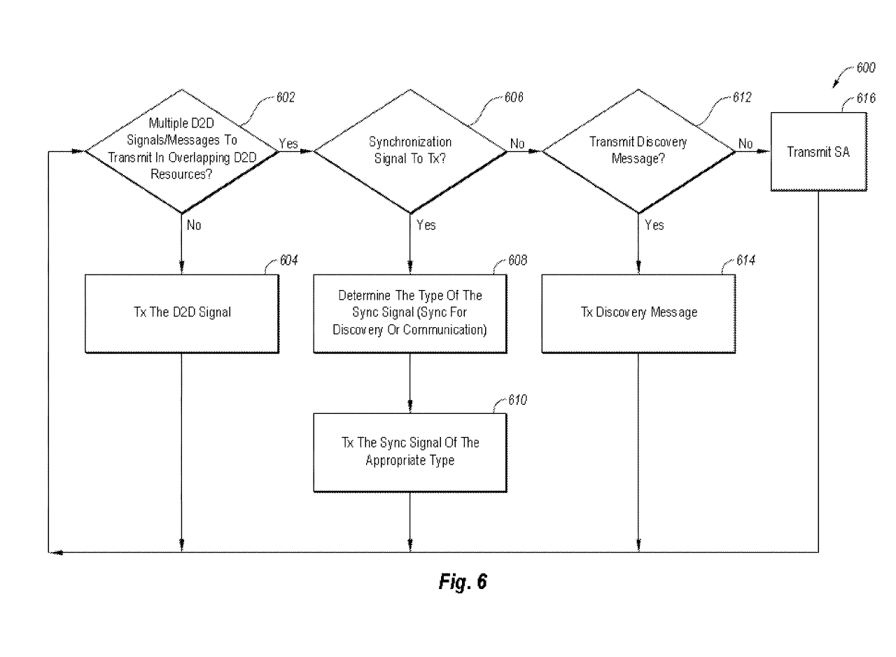

For a D2D RX wireless device 104, 202, it may receive in all the possible D2D signal/message formats or it may be left as a wireless device 104, 202 implementation issue. FIG. 6 illustrates a flowchart of an example method 600 of resource configuration and wireless device behavior, arranged in accordance with at least one embodiment described herein. The method 600 of FIG. 6 may be implemented, in whole or in part, by the access point 102 or wireless devices 104, 202 of FIG. 1 or 2, an eNB, a UE, or other LTE-A network element, computing device, or communication device. In an example implementation, the method 600 of FIG. 6 may be implemented by the wireless device 104, 202 of FIGS. 1 and 2.

The method 600 of FIG. 6 may include determining 602 whether there are multiple D2D signals and/or messages to transmit in overlapping D2D resources. In response to determining that there are not multiple D2D signals and/or messages to transmit in overlapping D2D resources (“No” at block 602), the method 600 may also include transmitting 604 the D2D signals and/or messages in non-overlapping D2D resources. In response to determining that there are multiple D2D signals and/or messages to transmit in overlapping D2D resources (“Yes” at block 602), the method 600 may also include determining 606 whether the multiple D2D signals and/or messages include a synchronization signal to transmit. In response to the multiple D2D signals and/or messages including a synchronization signal to transmit (“Yes” at block 606), the method 600 may also include determining 608 a type of the synchronization signal (e.g., for discovery or communication) and transmitting 610 the synchronization signal of the appropriate type. In response to the multiple D2D signals and/or messages not including a synchronization signal to transmit (“No” at block 606), the method 600 may also include determining 612 whether the multiple D2D signals and/or messages include a discovery message. In response to the multiple D2D signals including a discovery message (“Yes” at block 612), the method 600 may also include transmitting 614 the discovery message. In response to the multiple D2D signals not including a discovery message (“No” at block 612), the method 600 may also include transmitting an SA.

Embodiments described herein may include one or more non-transitory computer-readable media having computer instructions stored thereon that are executable by a processor device to perform or control performance of one or more of the operations of FIG. 6. For example, the memory 234 and/or the data storage 236 of the wireless device 202 of FIG. 2 may have computer instructions stored thereon that are executable by the processor 232 of FIG. 2 to perform or control performance of one or more operations of FIG. 6, such as one or more of blocks 602, 604, 606, 608, 610, 612, 614, and/or 616.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method of power control for synchronization signals, the method comprising:
at a wireless device, receiving a signal from an access point that is determinative of a power control mode of the wireless device for transmission of device-to-device (D2D) synchronization signals; and
transmitting, by the wireless device, D2D synchronization signals according to the power control mode, wherein the power control mode includes a controlled power mode or a maximal power mode.

2. The method of claim 1, wherein:
the receiving comprises receiving a downlink control information (DCI), subframe 5 (DCI5) from the access point; and
the method further comprises determining, by the wireless device and based on the signal, the power control mode of the wireless device.

3. The method of claim 2, wherein:
the determining comprises:
determining that the power control mode comprises the controlled power mode in response to the DCI5 indicating that a scheduling assignment (SA) and data is to be transmitted with controlled power; and
determining that the power control mode comprises the maximal power mode in response to the DCI5 indicating that the SA and data is to be transmitted with maximal power; and
the transmitting comprises:
transmitting the D2D synchronization signals with controlled power in response to determining that the power control mode comprises the controlled power mode; and
transmitting the D2D synchronization signals with maximal power in response to determining that the power control mode comprises the maximal power mode.

4. The method of claim 3, wherein the DCI5 includes a transmission power control bit that indicates that the SA and data is to be transmitted with maximal power when the transmission power control bit is set and that indicates that the SA and data is to be transmitted with controlled power when the transmission power control bit is not set.

5. The method of claim 3, wherein:
the D2D synchronization signals are transmitted with controlled power when the SA and data are transmitted with controlled power; and
the D2D synchronization signals are transmitted with maximal power when the SA and data are transmitted with maximal power.

6. The method of claim 1, wherein the D2D synchronization signals comprise a primary D2D synchronization sequence transmission (PD2DSS), a secondary D2D synchronization sequence transmission (SD2DSS), a physical D2D synchronization channel (PD2DSCH), or a combination thereof.

7. The method of claim 1, wherein:
the receiving comprises receiving a radio resource control (RRC) signal from the access point;
the RRC signal includes a dedicated bit that indicates the power control mode as being the controlled power mode or the maximal power mode;
the dedicated bit includes a first value that indicates the maximal power mode or a second value that indicates the controlled power mode; and
the transmitting comprises:
transmitting the D2D synchronization signals with maximal power in response to the dedicated bit including the first value; and
transmitting the D2D synchronization signals with controlled power in response to the dedicated bit including the second value.

8. The method of claim 1, wherein:
the receiving comprises receiving a signal from the access point that is effective to configure (alpha, P0) parameters of the wireless device that control transmission power at the wireless device of the D2D synchronization signals; and
the transmitting comprises:
transmitting the D2D synchronization signals with maximal power in response to the (alpha, P0) parameters being configured for maximal power mode; and
transmitting the D2D synchronization signals with controlled power in response to the (alpha, P0) parameters being configured for controlled power mode.

9. A non-transitory computer-readable medium having computer instructions stored thereon that are executable by a processor device to perform or control performance of operations comprising:
at a wireless device, receiving a signal from an access point that is determinative of a power control mode of the wireless device for transmission of device-to-device (D2D) synchronization signals; and
transmitting, by the wireless device, D2D synchronization signals according to the power control mode, wherein the power control mode includes a controlled power mode or a maximal power mode.

10. The non-transitory computer-readable medium of claim 9, wherein:
the receiving comprises receiving a downlink control information (DCI), subframe 5 (DCI5) from the access point; and
the operations further comprise determining, by the wireless device and based on the signal, the power control mode of the wireless device.

11. The non-transitory computer-readable medium of claim 10, wherein:
the determining comprises:
determining that the power control mode comprises the controlled power mode in response to the DCI5 indicating that a scheduling assignment (SA) and data is to be transmitted with controlled power; and
determining that the power control mode comprises the maximal power mode in response to the DCI5 indicating that the SA and data is to be transmitted with maximal power; and
the transmitting comprises:
transmitting the D2D synchronization signals with controlled power in response to determining that the power control mode comprises the controlled power mode; and
transmitting the D2D synchronization signals with maximal power in response to determining that the power control mode comprises the maximal power mode.

12. The non-transitory computer-readable medium of claim 11, wherein the DCI5 includes a transmission power control bit that indicates that the SA and data is to be transmitted with maximal power when the transmission power control bit is set and that indicates that the SA and data is to be transmitted with controlled power when the transmission power control bit is not set.

13. The non-transitory computer-readable medium of claim 11, wherein:
the D2D synchronization signals are transmitted with controlled power when the SA and data are transmitted with controlled power; and
the D2D synchronization signals are transmitted with maximal power when the SA and data are transmitted with maximal power.

14. The non-transitory computer-readable medium of claim 9, wherein the D2D synchronization signals comprise a primary D2D synchronization sequence transmission (PD2DSS), a secondary D2D synchronization sequence transmission (SD2DSS), a physical D2D synchronization channel (PD2DSCH), or a combination thereof.

15. The non-transitory computer-readable medium of claim 9, wherein:
the receiving comprises receiving a radio resource control (RRC) signal from the access point;
the RRC signal includes a dedicated bit that indicates the power control mode as being the controlled power mode or the maximal power mode;
the dedicated bit includes a first value that indicates the maximal power mode or a second value that indicates the controlled power mode; and
the transmitting comprises:
transmitting the D2D synchronization signals with maximal power in response to the dedicated bit including the first value; and
transmitting the D2D synchronization signals with controlled power in response to the dedicated bit including the second value.

16. The non-transitory computer-readable medium of claim 9, wherein:
the receiving comprises receiving a signal from the access point that is effective to configure (alpha, P0) parameters of the wireless device that control transmission power at the wireless device of the D2D synchronization signals; and
the transmitting comprises:
transmitting the D2D synchronization signals with maximal power in response to the (alpha, P0) parameters being configured for maximal power mode; and
transmitting the D2D synchronization signals with controlled power in response to the (alpha, P0) parameters being configured for controlled power mode.

17. A wireless device, comprising:
a processor; and
a non-transitory computer-readable medium communicatively coupled to the processor and having computer instructions stored thereon that are executable by the processor to perform or control performance of operations comprising:
receiving a signal from an access point that is determinative of a power control mode of the wireless device for transmission of device-to-device (D2D) synchronization signals; and
transmitting D2D synchronization signals according to the power control mode, wherein the power control mode includes a controlled power mode or a maximal power mode.

18. The wireless device of claim 17, wherein:
the receiving comprises receiving a downlink control information (DCI), subframe 5 (DCI5) from the access point; and
the operations further comprise determining, based on the signal, the power control mode of the wireless device.

19. The wireless device of claim 17, wherein:
the receiving comprises receiving a radio resource control (RRC) signal from the access point;
the RRC signal includes a dedicated bit that indicates the power control mode as being the controlled power mode or the maximal power mode;
the dedicated bit includes a first value that indicates the maximal power mode or a second value that indicates the controlled power mode; and
the transmitting comprises:
transmitting the D2D synchronization signals with maximal power in response to the dedicated bit including the first value; and
transmitting the D2D synchronization signals with controlled power in response to the dedicated bit including the second value.

20. The wireless device of claim 17, wherein:
the receiving comprises receiving a signal from the access point that is effective to configure (alpha, P0) parameters of the wireless device that control transmission power at the wireless device of the D2D synchronization signals; and
the transmitting comprises:
transmitting the D2D synchronization signals with maximal power in response to the (alpha, P0) parameters being configured for maximal power mode; and
transmitting the D2D synchronization signals with controlled power in response to the (alpha, P0) parameters being configured for controlled power mode.
